(19) United States
(12) Patent Application Publication
(10) Pub. No.: US 2009/0185455 A1
(43) Pub. Date: Jul. 23, 2009

(54) Aquatic Event Timer Apparatus and Methods

(75) Inventors: Michael Medina-Brodsky, Longmont, CO (US); Brett Anderson, Fort Collins, CO (US); Robert Clauson, Windsor, CO (US); Craig Jacobs, Fort Collins, CO (US)

Correspondence Address: SANTANGELO LAW OFFICES, P.C., 125 SOUTH HOWES, THIRD FLOOR, FORT COLLINS, CO, 80521, US

(73) Assignee: Colorado Time Systems, LLC, Loveland, CO (US)

(21) Appl. No.: 12/018,320

(22) Filed: Jan. 23, 2008

(51) Int. Cl. G04F 10/00

(52) U.S. Cl. 368/107

(57) ABSTRACT

The inventive technology, in embodiments, includes an aquatic event timer apparatus that comprises at least two independent, touch actuated electrical switches; and a structural connector that adjacently connects them, where the apparatus is configured for establishment within lane markers defining a regulation size swim lane, at the end of the swim lane, and at least partially underwater. Other aspects of the inventive technology address an aquatic event timer apparatus that comprises a first, independent, swim competition type, touch actuated electrical switch that is configured for establishment within swim lane markers, and aside at least a second, independent, swim competition type, touch actuated electrical switch.

### I. BACKGROUND

As is well known, many competitive aquatic events, particularly swim racing, require timing of competing individuals. Indeed, there is available today a variety of advanced, programmable timing systems that can electronically record, display, save and manipulate as necessary all sorts of swim event times, including, but not limited to, elapsed times, and individual and cumulative lap split times of several competing or training swimmers. Electronic training tools are also available to perform similar functions, and may also feature specialized pacing capabilities that find particular applicability during swim training.

Although timing systems are not a requisite tool for competitive swim training, there is no doubt that timed training is more effective in improving competitive swimmers' speeds than un-timed training. As such, swimmers would, preferably, each have his/her own timer during training. This poses no problem at all when the pool is large enough (or the number of training swimmers small enough) so that each training swimmer can swim in his/her own regulation size lane (as is required during competition and, as used herein, regulation size means from 5½ feet to 9 feet wide). Simply, in such case, the large, touch actuated electrical switches (often referred to more colloquially as “touch pads”), each of which is designed and sized for use by one swimmer during competitive swim events (competitive swim event switches), can be used during “one swimmer per lane” training. Indeed, training in a single swimmer lane with a single, large, touch actuated electrical switch at one or both ends of the lane best simulates competitive swim meet conditions and, for that reason, is preferred by many swimmers.

But, often, there are greater demands on a pool available during training times, and training swimmers do not have the luxury of one swimmer per lane. In such a situation, swimmers share lanes during training; indeed, even the smallest regulation size lane is large enough to accommodate more than one swimmer. The problem with more than one swimmer per lane training typically arises not from lane size (presuming only a reasonable number of swimmers train in each lane), but rather from the unavailability of swim competition type, touch actuated electrical switches small enough so that more than one switch can fit into a single regulation sized lane. The traditional competitive swim event, touch actuated electrical switches are, as mentioned, large (even the smallest is larger than one half the width of even the largest regulation size lane) and are simply too large to fit more than one per lane. As such, before the release of the inventive technology disclosed herein, two or more swimmers forced to train in a single lane either: (a) forego independent (one swimmer per switch), automatic timing for each swimmer (perhaps a non-automatic, hand held stopwatch could be used by a coach or others); or (b) settle on using, e.g., a personal underwater, lap counting and timing clock, which, although excellent for its intended purpose, does not include a sufficiently large touch pad and for that reason, inter alia, simply cannot include a swim competition type switch. Either alternative potentially compromises training effectiveness. The inventive technology, in particular embodiments, addresses one or more of such problems.

### II. SUMMARY OF THE INVENTIVE TECHNOLOGY

The inventive technology, in embodiments, includes an aquatic event timer apparatus that comprises at least two independent, touch actuated electrical switches; and a structural connector that adjacently connects the at least two independent, touch actuated electrical switches, wherein the apparatus is configured for establishment within lane markers defining a regulation size swim lane, at the end of the swim lane, and at least partially underwater. Other aspects of the inventive technology include an aquatic event timer apparatus that comprises a first, independent, swim competition type, touch actuated electrical switch, wherein the first, independent, swim competition type, touch actuated electrical switch is configured for establishment within the lane markers defining a regulation size swim lane, at the end of the swim lane, at least partially underwater, and aside at least a second, independent, swim competition type, touch actuated electrical switch, wherein the aquatic event timer apparatus has an apparatus horizontal width that is less than 55 inches, and wherein the second, independent, swim competition type, touch actuated electrical switch has the apparatus horizontal width.

It is an objective of at least one embodiment of the inventive technology to provide a swim competition type, touch actuated electrical switch that is sized such that more than one can fit in a regulation size swim lane.

It is an objective of at least one embodiment of the inventive technology to provide an aquatic event timer apparatus that includes two or more structurally connected, independent, swim competition type, touch actuated electrical switches, where such apparatus is sized to fit in a regulation size lane of a swim pool.

It is an objective of at least one embodiment of the inventive technology to provide an aquatic event timer apparatus that includes at least two independent, swim competition type, touch actuated electrical switches, wherein each switch exhibits a visual design that is distinguishable, by a swimmer, from the visual design of a different, immediately adjacent, independent, touch actuated electrical switches. Of course, other objects and advantages may be disclosed in the following description.

### III. BRIEF DESCRIPTION OF THE DRAWINGS

FIG. 1A shows an upper view, FIG. 1B shows a frontal view, and FIG. 1C shows a side view of an embodiment of an aspect of the inventive technology, a multi-switch aquatic event timer apparatus.

FIG. 2 shows a perspective view of an embodiment of a multi-switch aquatic event timer apparatus.

FIG. 3 shows a perspective view of an embodiment of a multi-switch aquatic event timer apparatus.

FIG. 4 shows a frontal view of an embodiment of a multi-switch aquatic event timer apparatus.

FIG. 5 shows a frontal view of an embodiment of a multi-switch aquatic event timer apparatus.

FIG. 6 shows a perspective view of an embodiment of a multi-switch aquatic event timer apparatus.

FIGS. 7A and 7B each show a frontal view of an embodiment of a multi-switch aquatic event timer apparatus.

FIG. 8 shows a frontal view of an embodiment of a multi-switch aquatic event timer apparatus.

FIG. 9A shows a frontal view of an embodiment of an aspect of the inventive technology;

FIG. 9B shows flat wall mount hardware for attaching apparatus at the end of a pool lane while FIG. 9C shows gutter mount hardware.

FIG. 10 shows a perspective view of an embodiment of an aspect of the inventive technology.

FIG. 11 shows a perspective view of an embodiment of an aspect of the inventive technology.

FIG. 12 shows a perspective view of an embodiment of an aspect of the inventive technology.

FIG. 13 shows a perspective view of an embodiment of an aspect of the inventive technology.

FIG. 14 shows an embodiment of the inventive technology, with possible electrical componentry and an example of a timer that may be used.

FIG. 15 shows an embodiment of the inventive technology, with possible electrical componentry and an example of a timer that may be used.

FIG. 16 shows an embodiment of the inventive technology, with possible electrical componentry and an example of a timer that may be used.

FIG. 17 shows an embodiment of the inventive technology, with possible electrical componentry and an example of a timer that may be used.

### IV. DETAILED DESCRIPTION OF THE PREFERRED EMBODIMENTS

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

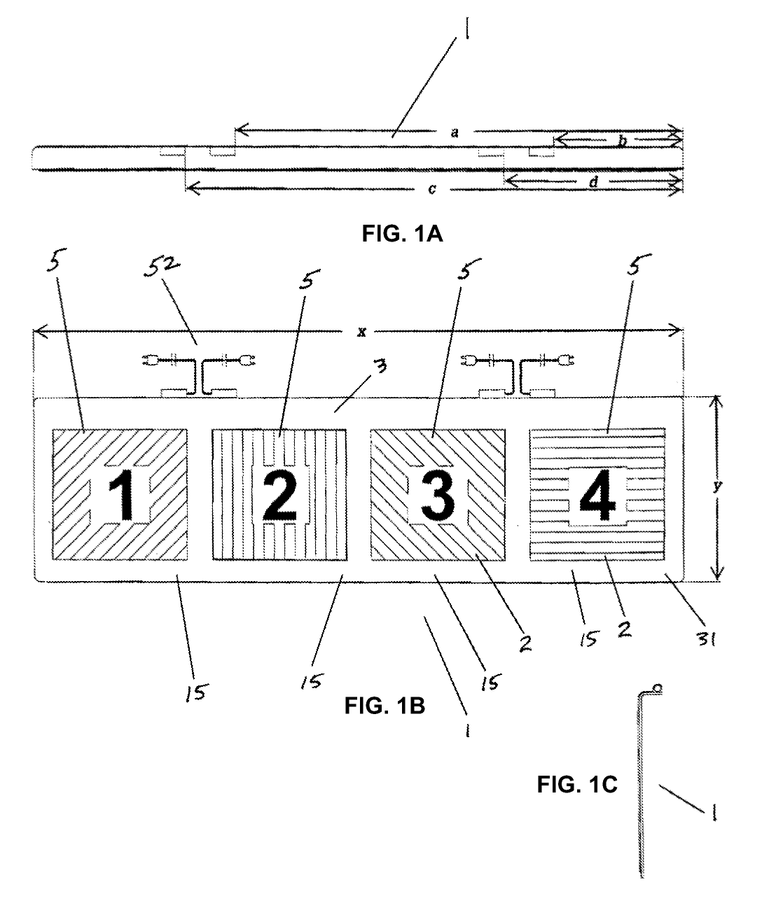

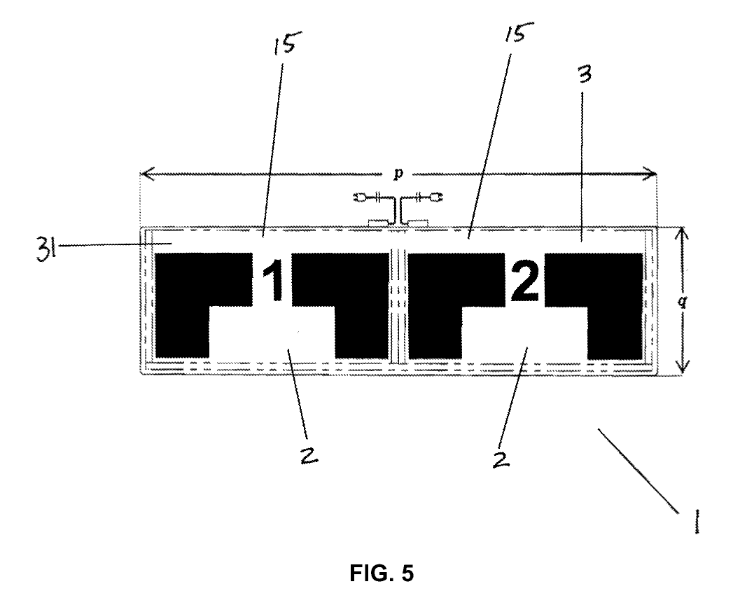

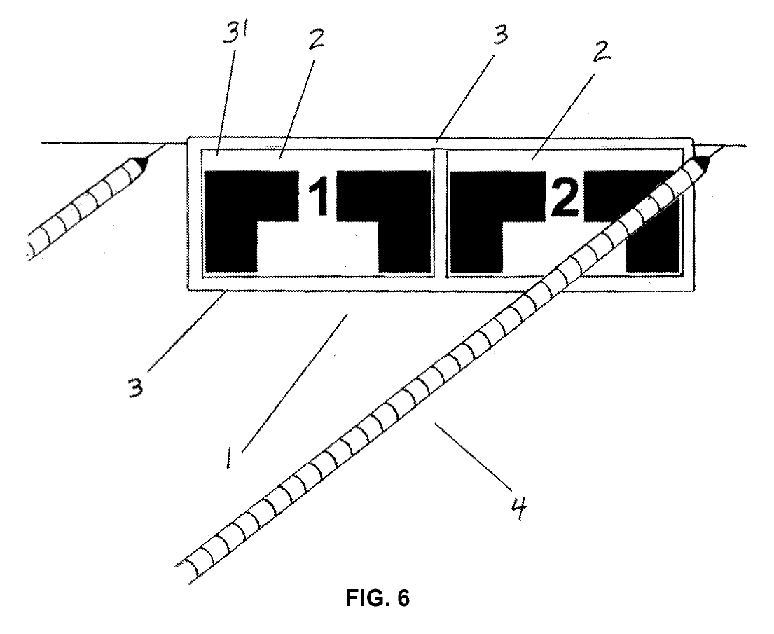

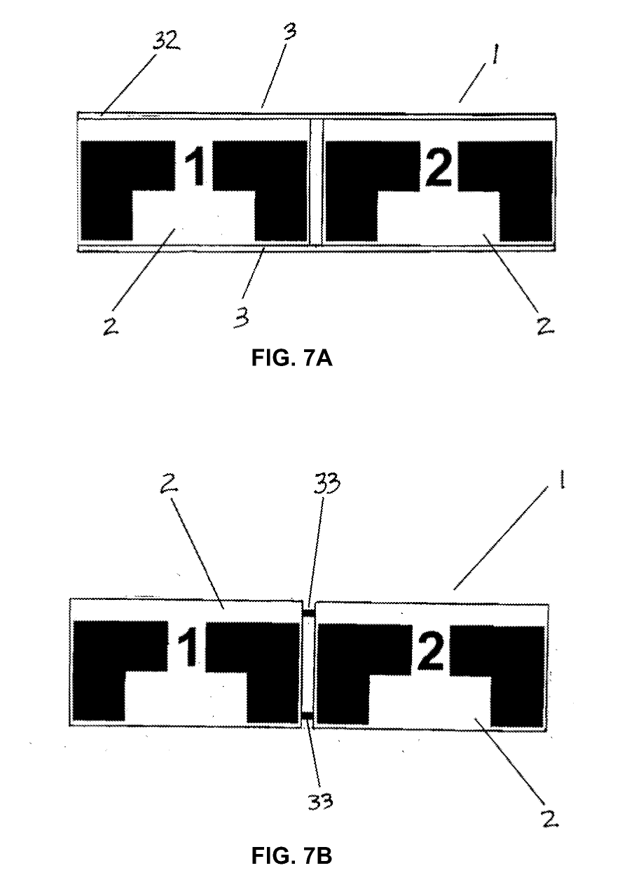

At least one embodiment of the inventive technology may be an aquatic event timer apparatus 1 that comprises at least two independent, touch actuated electrical switches 2 and a structural connector 3 that adjacently connects the at least two independent, touch actuated electrical switches. Preferably, the apparatus is configured for establishment within lane markers 4 (including lane lines and gutters) defining a regulation size swim lane (from 5½ feet to 9 feet in width), at the end of the swim lane, and at least partially underwater. As such, in such preferred embodiments, the width of the apparatus (see, e.g., “x” of FIG. 1B or “p” of FIG. 5) is less than from 5½ feet, less than 9 feet, or less than any distance from 5½ feet to 9 feet. FIG. 1A shows widths “a”, “b”, “c”, and “d”, of a four switch apparatus; their specific size may be proportional of the total width “x” of FIG. 1B. Specific exemplary proportions may be easily estimated from the width ratios (e.g., relative to “x”) as scaled from FIGS. 1A and 1B. Heights “y” and “q” of FIGS. 1B and 5, respectively, may assume a wide variety of ranges, including but not limited to those heights of conventional touch pad switches in use at the time of the filing of this application. As such, the height of any of the switch apparatus, whether they include one or more switches, may be, as but one example, from 1 to 3 feet in height. Of course, some sizes might not meet competitive swim meet regulations (whether because of height or width); such apparatus may simply find use during training alone.

It is of note that particular designs may include a touch pad portion that is above the water surface to provide a touch target for backstroke events where the swimmer breaks the threshold above water. Further, as is understood from above, the term independent as used herein in connection with switches implies the independence of one switch and the times it records of the physical touches (e.g., occurring at the end of a lap) and associated recorded times of a different switch, even where, as in this particular embodiment, such different switch is structurally connected. Additionally, it is of note that any device that opens and/or closes an electrical circuit, perhaps upon manipulation (e.g., touching or hitting) by a human is an electrical switch (even though it might also involve mechanical principles).

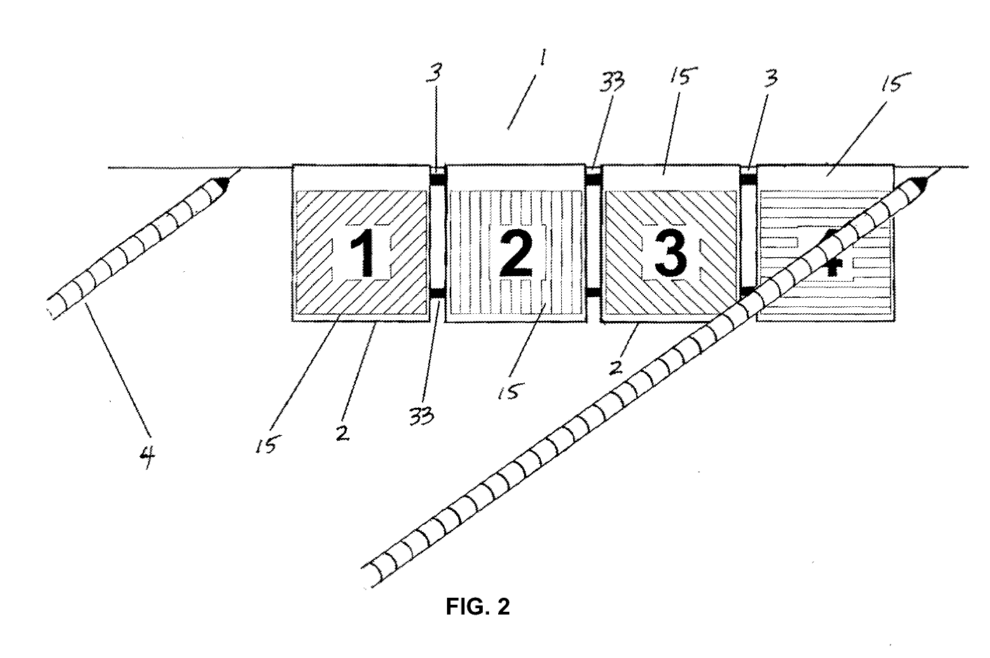

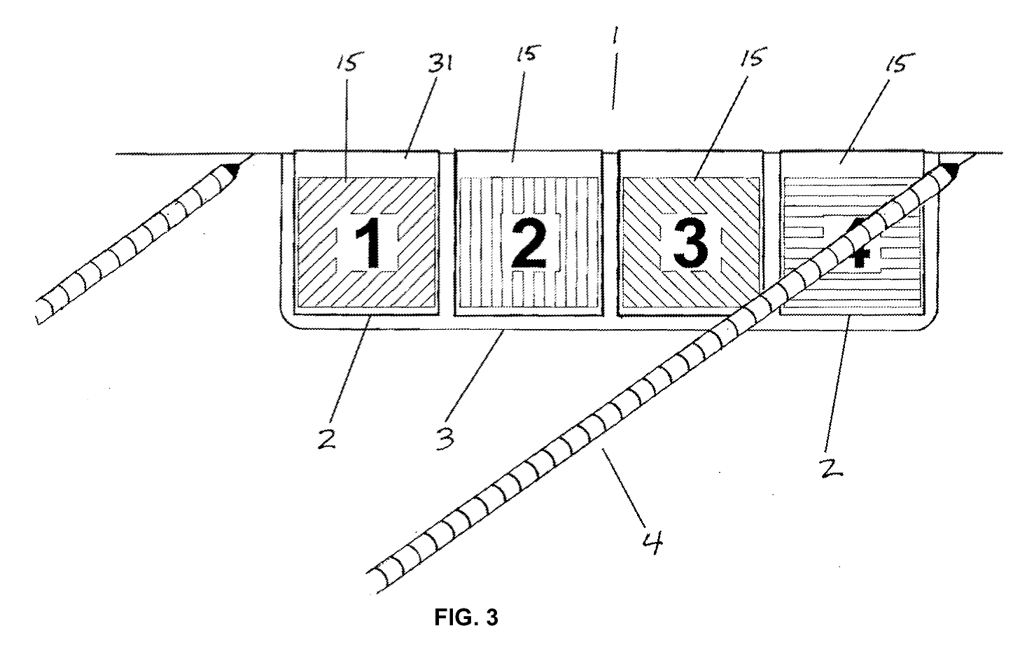

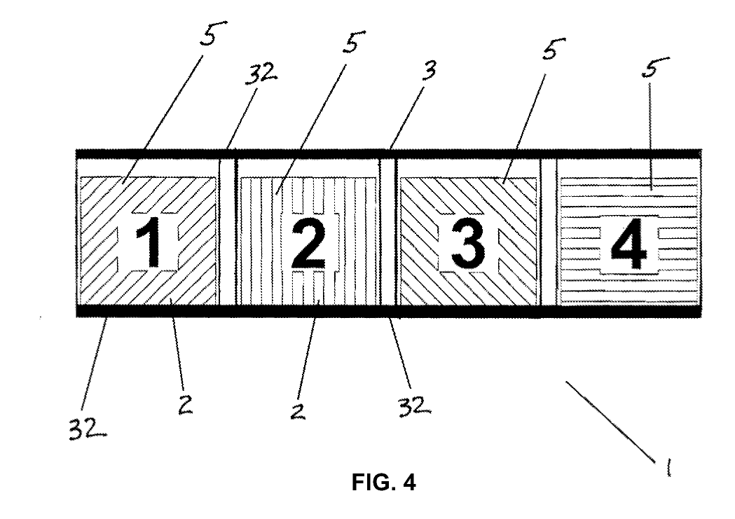

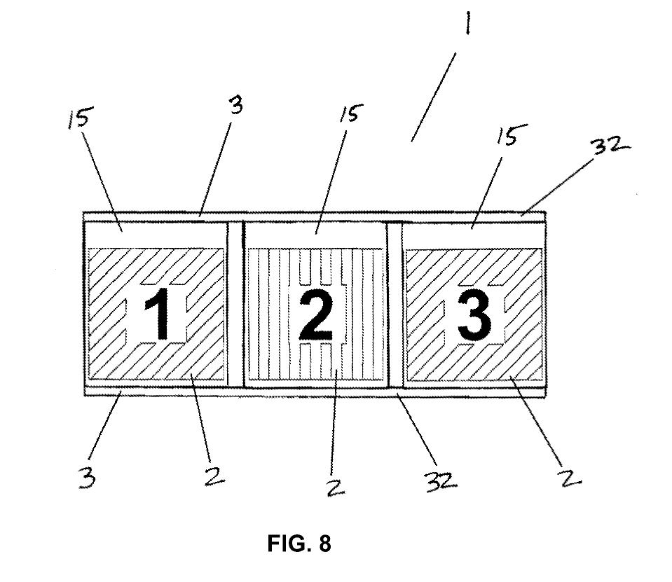

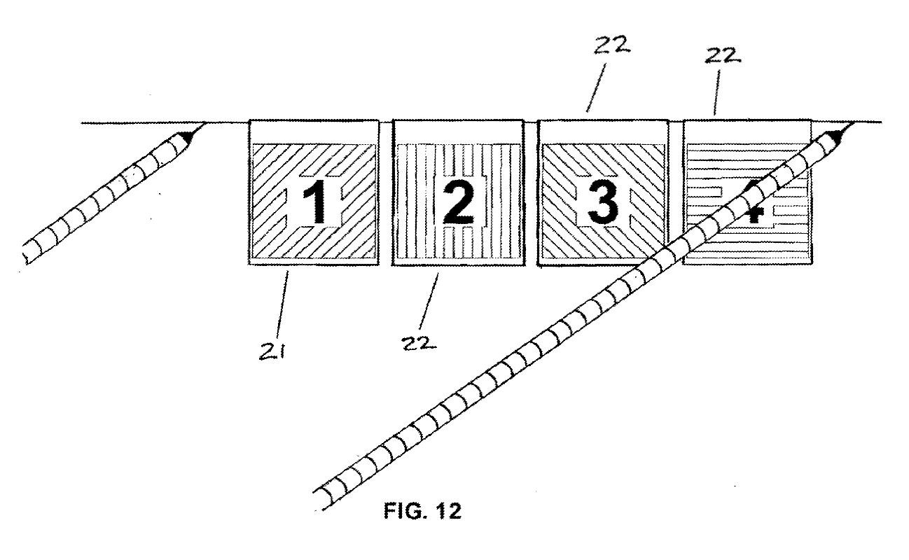

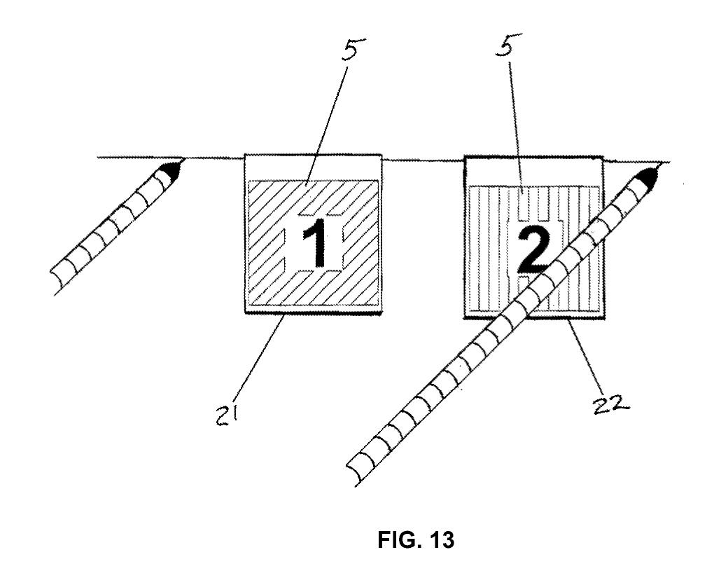

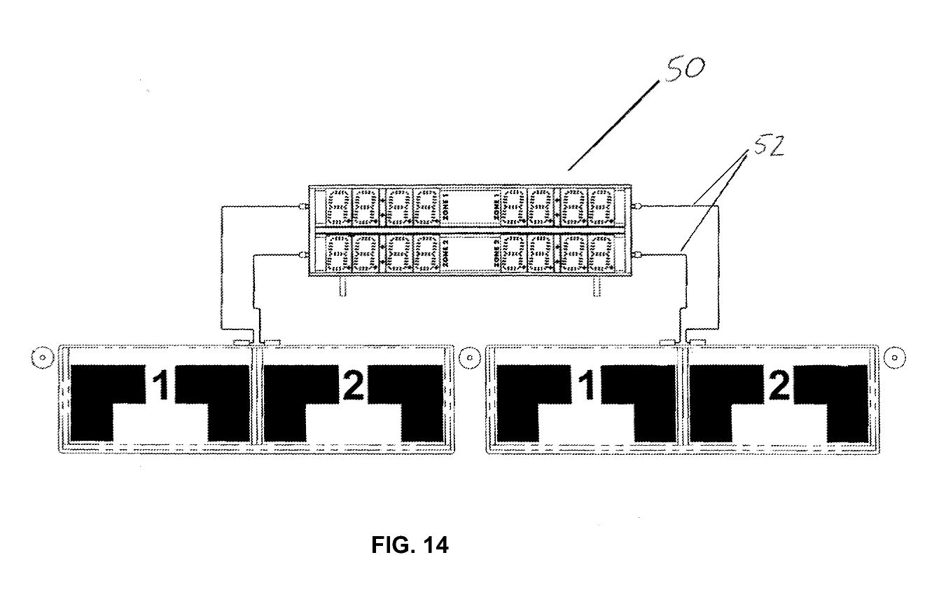

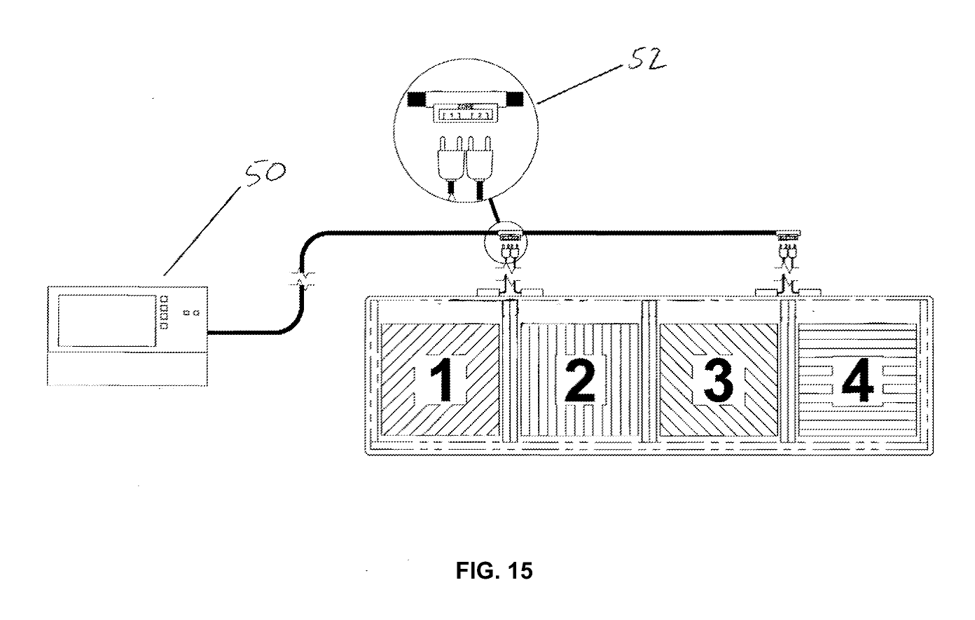

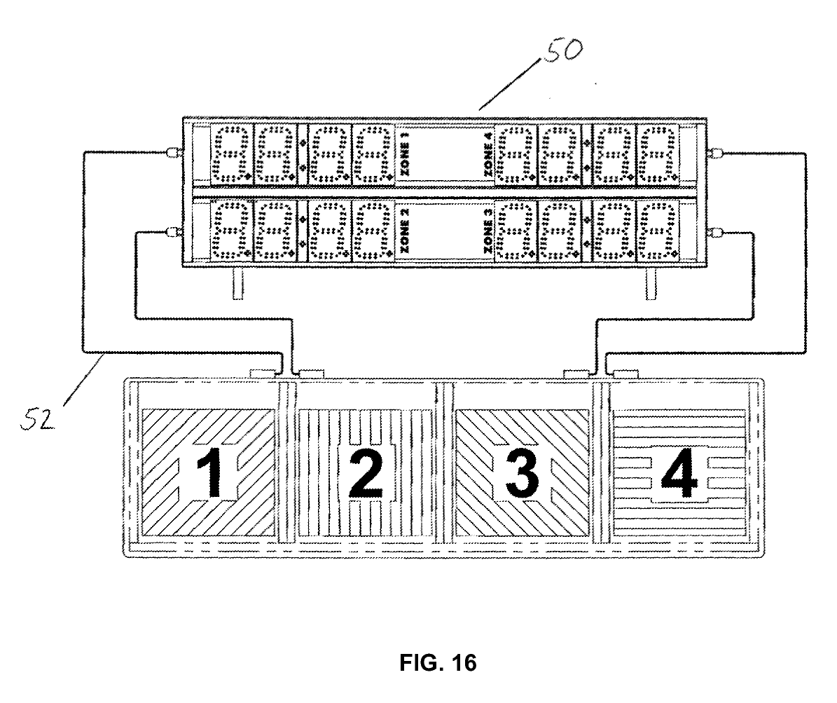

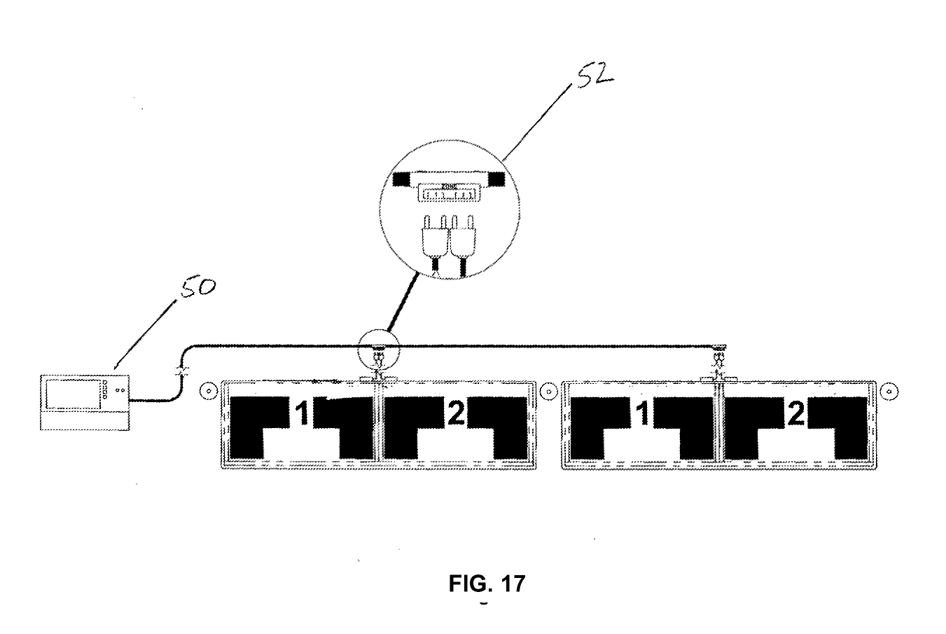

In preferred embodiments, each of the at least two independent, touch actuated electrical switches exhibits a visual design 5 that is distinguishable, by a swimmer, from the visual design of a different, immediately adjacent (whether it be connected thereto or not), independent, touch actuated electrical switch. Of course, such helps a swimmer discern which switch is his/hers when more than one swimmer, and therefore more than one switch, is in a single lane. Shown in FIGS. 1B, 2, 3, 4, 8 and 12 are just a few of the many different possible switch designs that may accomplish the intended purpose. It is of note that in embodiments having different visual switch designs, where three or more switches are in a single lane, not all switches need to have a different design, as immediately adjacent switches featuring different designs will accomplish the intended purpose. As such, in a three switch per lane apparatus as shown in FIG. 8, the two outer switches may have identical designs, and in a four switch apparatus, the first and third (from the left) may feature the same first visual design and the second and fourth switches may feature the same second visual design (that is different from the first visual design). Of course, in alternative embodiments, each switch, regardless of how many are in a single design, may have a different design.

In embodiments with a structural connector 3, such connector may take any of a variety of forms. It may be an apparatus housing 31 (or part thereof), apparatus frame 32 (or part thereof), bars 33, rods and/or magnetic, or even hook and loop, as but a few examples. The term housing includes but is not limited to an outer shell; it may provide structure that does more than simply connect the switches, such as provide the structure that supports each individual switch. Generally, the term frame refers to a structure that supports each switch, a function distinct from connecting switches. However, although its focus may be on switch support, a frame may also connect the switches. Further, the term frame generally includes to a skeletal support structure. A housing may be a type of frame, if indeed it supports one or more switches. Bar(s) may act as structural connectors, whether as part of a skeletal frame or simply acting as connectors. In particular embodiments, the structural connector may allow for the disconnection of one or more switches from immediately adjacent switches (whether such switches physically abut each other or not). As such, a single switch may, in particular embodiments, be usable on its own, or may be connected to one or more other switches (and vice versa). It is of note that such disconnect capability is not a requisite feature of the structural connector, but may indeed afford advantages relative to embodiments having a structural connector that does not allow disconnection, and subsequent re-connection of switches.

In preferred embodiments, the at least two independent, touch actuated electrical switches are at least two independent, swim competition type, touch actuated electrical switches 15. It is of note that the term “swim competition type”, when used in connection with “switch” (whether that switch be connected to another switch or not), does not necessarily imply that such switch meets regulatory requirements that switches must meet for competitive swim events. It merely implies that such switches—in stark contrast with personal underwater, lap counting and timing clocks—emulate, perhaps to the largest extent possible given the intended application (and thus do not necessarily mimic) salient features of those switches that do meet regulations for competition switches—large size and distinct visual design, thereby lessening the effort required of an “other-focused” swimmer to locate and hit his/her switch. As such, in preferred embodiments that include a structural connector, each of the at least two independent, touch actuated electrical switches has a horizontal width that is greater than 50 inches, 42 inches, 38 inches, 30 inches, 22 inches or 16 inches. In order that more than one switch may fit in a lane, each such switch may be less than 58 inches, 50 inches, 42 inches, 34 inches, 26 inches or 18 inches. Accordingly, swim competition type, touch actuated electrical switches 15 may be from 16″-58″. Of course, the more switches per lane, the smaller each switch, typically—whether the at least two independent, touch actuated electrical switches be either only two independent, touch actuated electrical switches or only four independent, touch actuated electrical switches. However, in emphasizing salient features of competitive swim event switches (which meet regulations for use during competition), a swim competition type switch will typically be sized “on the larger end”; its specific size may, of course, depend on potential application of the particular switch and, more specifically, on the greatest number of switches that might conceivably be used in a single lane.

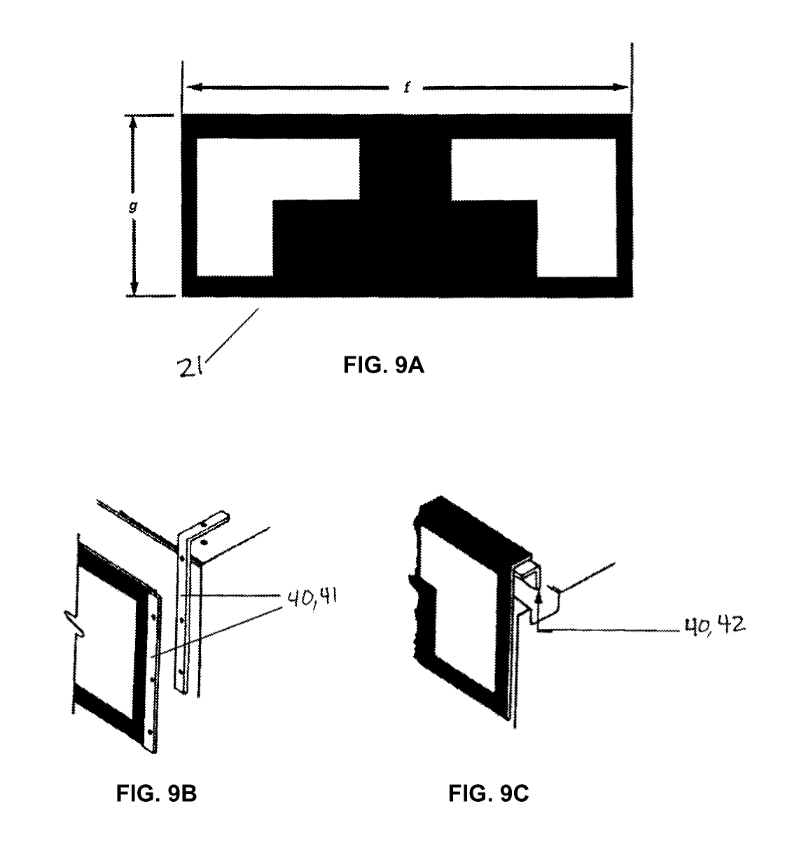

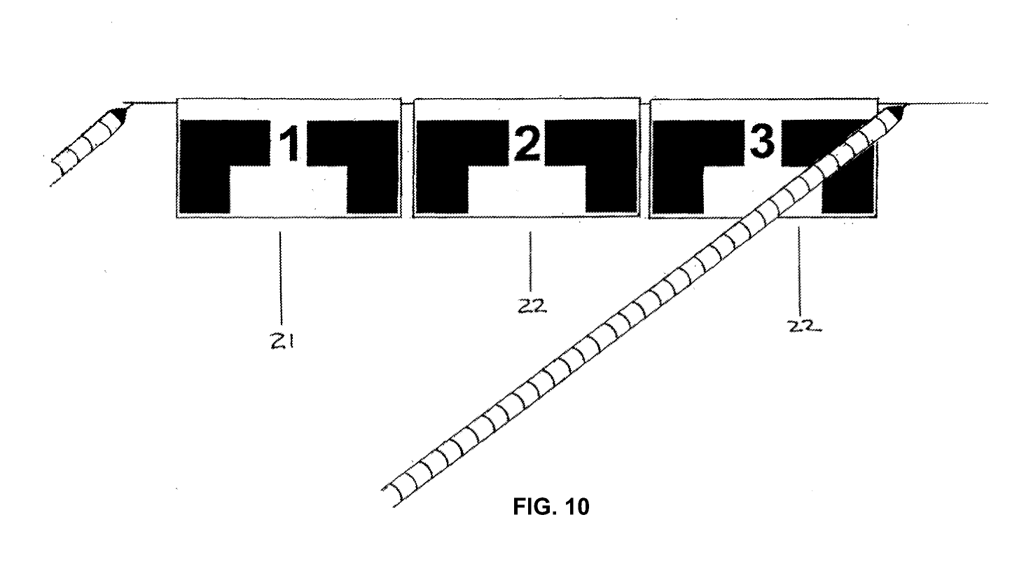

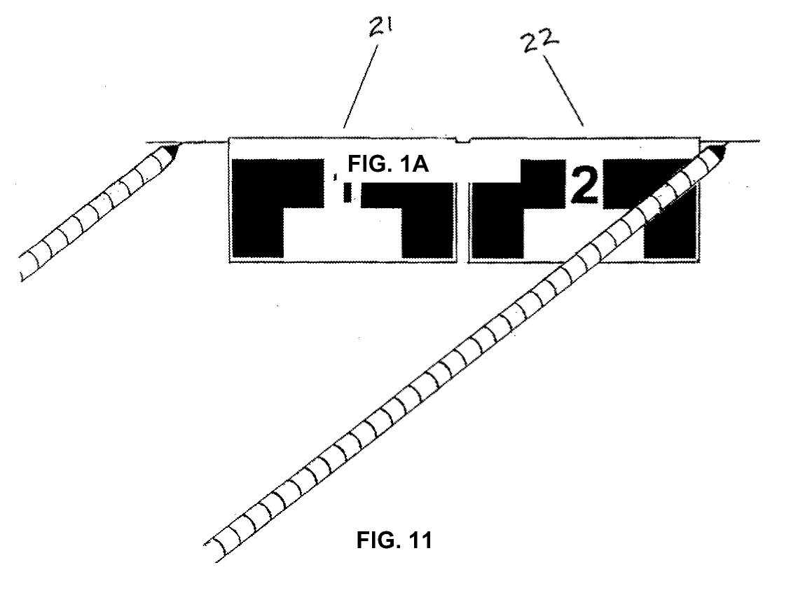

Particular embodiments of the inventive technology may focus on an apparatus that does not necessarily require structural connection between switches. Indeed, such embodiments may include unconnected switches that are small enough such that more than one can fit in a single lane. In such embodiments, an aquatic event timer apparatus may comprise a first, independent, swim competition type, touch actuated electrical switch 21 that is configured for establishment within lane markers 4 defining a regulation size swim lane, at the end of the swim lane, at least partially underwater, and aside (e.g., within 20 inches or 30 inches, whether connected thereto or not) at least a second, independent, swim competition type, touch actuated electrical switch 22. Further, in particular embodiments, the aquatic event timer apparatus may have an apparatus horizontal width (see “f” of FIG. 9A) that is less than 55 inches, and the second, independent, swim competition type, touch actuated electrical switch has such apparatus horizontal width. The apparatus horizontal width (e.g., “f” of FIG. 9A) may be less than a distance selected from the group consisting of 50 inches, 42 inches, 34 inches, 26 inches and 18 inches. Heights (e.g., “g” of FIG. 9A) may be among the following ranges (as but a few examples): 18-40 inches, 21-37 inches and 24-34 inches. Further, in particular embodiments, each of the first and second independent, swim competition type, touch actuated electrical switches 21, 22 may exhibit a visual design 5 that is distinguishable from the other of the first or second independent, swim competition type, touch actuated electrical switch. As mentioned, in certain embodiments, the first and second independent, swim competition type, touch actuated electrical switches may, but need not be, structurally unconnected.

The apparatus may further comprise a timer 50 that is electrically responsive to the touch actuated electrical switch(es) through the use of electrical componentry 52. Timer, as defined herein, is a broad term; it may display the recorded time, whether it be a lap split, elapsed time or other. As is well known, the timer, alternatively or in addition to any display functionalities, may be a time controller or time manager in that it may manipulate recorded times in some fashion (e.g., in order to generate lap times) and may include well known training tools such as a pacer and/or a “time to beat”, as but two examples of possible functionalities. Often such timers are software based. It is also of note that the inventive apparatus may include hardware 40 configured to enable attachment of the switch to a pool wall at the end of a lane, including but not limited to gutter mount hardware 42 and flat wall mount hardware 41. It is of note that any of the inventive apparatus can be made, or any of the inventive methods employed, using manufacturing and/or use techniques that are well known to those of ordinary skill in the art.

It is of note that related aquatic event timer methods may comprise the step of structurally connecting at least two independent, swim competition type, touch actuated electrical switches adjacent one another to form an aquatic event timer apparatus, wherein the aquatic event timer apparatus is configured for establishment within lane markers defining a regulation size swim lane, at the end of the swim lane, and at least partially underwater. Another aquatic event timer method may comprise the steps of establishing an independent, swim competition type, touch actuated electrical switch within lane markers defining a regulation size swim lane, at the end of the swim lane, and at least partially underwater; and establishing a first additional, independent, swim competition type, touch actuated electrical switch within the lane markers, at the end of the swim lane, at least partially underwater, and adjacent the independent, swim competition type, touch actuated electrical switch.

As can be easily understood from the foregoing, the basic concepts of the present invention may be embodied in a variety of ways. It involves both timing techniques as well as devices to accomplish the appropriate timing. In this application, the timing techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims included herein.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “timer” should be understood to encompass disclosure of the act of “timing”—whether explicitly discussed or not—and, conversely, were there effectively disclosure of the act of “timing”, such a disclosure should be understood to encompass disclosure of a “timer” and even a “means for timing” Such changes and alternative terms are to be understood to be explicitly included in the description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the timing devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

In addition and as to computer aspects and each aspect amenable to programming or other electronic automation, the applicant(s) should be understood to have support to claim and make a statement of invention to at least: xvi) processes performed with the aid of or on a computer as described throughout the above discussion, xv) a programmable apparatus as described throughout the above discussion, xvi) a computer readable memory encoded with data to direct a computer comprising means or elements which function as described throughout the above discussion, xvii) a computer configured as herein disclosed and described, xviii) individual or combined subroutines and programs as herein disclosed and described, xix) the related methods disclosed and described, xx) similar, equivalent, and even implicit variations of each of these systems and methods, xxi) those alternative designs which accomplish each of the functions shown as are disclosed and described, xxii) those alternative designs and methods which accomplish each of the functions shown as are implicit to accomplish that which is disclosed and described, xxiii) each feature, component, and step shown as separate and independent inventions, and xxiv) the various combinations and permutations of each of the above.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. An aquatic event timer apparatus comprising:
at least two independent, touch actuated electrical switches; and
a structural connector that adjacently connects said at least two independent, touch actuated electrical switches,
wherein said apparatus is configured for establishment within lane markers defining a regulation size swim lane, at the end of said swim lane, and at least partially underwater.

2. An aquatic event timer apparatus as described in claim 1 further comprising a timer electrically responsive to said at least two independent, touch actuated electrical switches.

3. An aquatic event timer apparatus as described in claim 2 further comprising at least one electrical training product electrically responsive to said at least two independent, touch actuated electrical switches.

4. An aquatic event timer apparatus as described in claim 1 wherein each of said at least two independent, touch actuated electrical switches exhibits a visual design that is distinguishable, by a swimmer, from the visual design of a different, immediately adjacent, independent, touch actuated electrical switches.

5. An aquatic event timer apparatus as described in claim 1 wherein said structural connector comprises an element selected from the group consisting of: apparatus housing, apparatus frame, bars and rods.

6. An aquatic event timer apparatus as described in claim 1 wherein said at least two independent, touch actuated electrical switches comprises either only two independent, touch actuated electrical switches or only four independent, touch actuated electrical switches.

7. An aquatic event timer apparatus as described in claim 1 wherein each of said at least two independent, touch actuated electrical switches has a horizontal width that is less than a distance selected from the group consisting of 58 inches, 50 inches, 42 inches, 34 inches, 26 inches and 18 inches.

8. An aquatic event timer apparatus as described in claim 1 further comprising hardware selected from the group consisting of gutter mount hardware and flat wall mount hardware.

9. An aquatic event timer apparatus as described in claim 1 wherein said at least two independent, touch actuated electrical switches are at least two independent, swim competition type, touch actuated electrical switches.

11. An aquatic event timer apparatus comprising:
a first, independent, swim competition type, touch actuated electrical switch,
wherein said first, independent, swim competition type, touch actuated electrical switch is configured for establishment within the lane markers defining a regulation size swim lane, at the end of said swim lane, at least partially underwater, and aside at least a second, independent, swim competition type, touch actuated electrical switch,
wherein said aquatic event timer apparatus has an apparatus horizontal width that is less than 55 inches, and
wherein said second, independent, swim competition type, touch actuated electrical switch has said apparatus horizontal width.

12. An aquatic event timer apparatus as described in claim 11 further comprising a timer electrically responsive to said first and second independent, swim competition type, touch actuated electrical switches.

13. An aquatic event timer apparatus as described in claim 12 further comprising at least one electrical training product electrically responsive to said first and second independent, swim competition type, touch actuated electrical switches.

14. An aquatic event timer apparatus as described in claim 11 wherein each of said first and second independent, swim competition type, touch actuated electrical switches exhibits a visual design that is distinguishable from the other of said first or second independent, swim competition type, touch actuated electrical switch.

15. An aquatic event timer apparatus as described in claim 11 wherein said first and second independent, swim competition type, touch actuated electrical switches are structurally unconnected.

16. An aquatic event timer apparatus as described in claim 11 wherein said apparatus horizontal width is less than a distance selected from the group consisting of 50 inches, 42 inches, 34 inches, 26 inches and 18 inches.

17. An aquatic event timer apparatus as described in claim 11 wherein aside comprises within 20 inches.

18. An aquatic event timer apparatus as described in claim 11 further comprising hardware selected from the group consisting of gutter mount hardware and flat wall mount hardware.

19. An aquatic event timer method comprising the steps of:
structurally connecting at least two independent, swim competition type, touch actuated electrical switches adjacent one another to form an aquatic event timer apparatus;
wherein said aquatic event timer apparatus is configured for establishment within lane markers defining a regulation size swim lane, at the end of said swim lane, and at least partially underwater.

20. An aquatic event timer apparatus as described in claim 19 further comprising the step of establishing a timer to be electrically responsive to said at least two independent, swim competition type, touch actuated electrical switches.

21. An aquatic event timer apparatus as described in claim 19 further comprising the step of establishing a visual design on each of said at least two independent, swim competition type, touch actuated electrical switches that is distinguishable, by a swimmer, from the visual design of a different, immediately adjacent independent, swim competition type, touch actuated electrical switches.

22. An aquatic event timer apparatus as described in claim 19 wherein said step of structurally connecting at least two independent, swim competition type, touch actuated electrical switches adjacent one another to form an aquatic event timer apparatus comprises the step of structurally connecting either only two or only four independent, swim competition type, touch actuated electrical switches adjacent one another.

23. An aquatic event timer apparatus as described in claim 19 wherein said step of structurally connecting at least two independent, swim competition type, touch actuated electrical switches adjacent one another to form an aquatic event timer apparatus comprises the step of structurally connecting at least two independent, swim competition type, touch actuated electrical switches that each have horizontal width that is less than a distance selected from the group consisting of 58 inches, 50 inches, 42 inches, 34 inches, 26 inches and 18 inches.

24. An aquatic event timer method comprising the steps of:
establishing an independent, swim competition type, touch actuated electrical switch within lane markers defining a regulation size swim lane, at the end of said swim lane, and at least partially underwater; and
establishing a first additional, independent, swim competition type, touch actuated electrical switch within said lane markers, at said end of said swim lane, at least partially underwater, and adjacent said independent, swim competition type, touch actuated electrical switch.

25. An aquatic event timer apparatus as described in claim 24 further comprising the step of structurally connecting said first additional independent, swim competition type, touch actuated electrical switch and said independent, swim competition type, touch actuated electrical switch.

26. An aquatic event timer apparatus as described in claim 24 further comprising the step of establishing a second additional, independent, swim competition type, touch actuated electrical switch within said lane markers, at said end of said swim lane, at least partially underwater, and adjacent said first additional, independent, swim competition type, touch actuated electrical switch.

27. An aquatic event timer apparatus as described in claim 24 further comprising the step of structurally connecting said second additional, independent, swim competition type, touch actuated electrical switch and said first additional, independent, swim competition type, touch actuated electrical switch.
